(19) United States
(12) Patent Application Publication
(10) Pub. No.: US 2009/0243893 A1
(43) Pub. Date: Oct. 1, 2009

(54) METHOD OF CODING A DIGITAL COLOR IMAGE INCLUDING MARKING INFORMATION

(75) Inventors: Eric Filliatre, Merignac (FR); Patrice Capircio, Le Taillan Medoc (FR)

Correspondence Address: LOWE HAUPTMAN & BERNER, LLP, 1700 DIAGONAL ROAD, SUITE 300, ALEXANDRIA, VA, 22314, US

(73) Assignee: THALES, Neuilly Sur Seine (FR)

(21) Appl. No.: 12/303,319

(22) PCT Filed: May 29, 2007
(86) PCT No.: PCT/EP2007/055201

§ 371 Date: Jan. 16, 2009

(30) Foreign Application Priority Data
Jun. 6, 2006 (FR) 0605002

(51) Int. Cl. G08B 21/00; G06T 11/20

(52) U.S. Cl. 340/945; 345/441

(57) ABSTRACT

The field of the invention is that of the dependability of operation of viewing systems. The field of application is more particularly that of cockpit systems on board aircraft. The invention relates to a method of coding the pixels of a color digital image comprising critical symbols represented by critical pixels, each colored pixel being coded on three digital components each comprising the same number of bits. The components of the critical pixels comprise on the one hand color information and on the other hand a marker also called a “tag” coded on at least one bit, said marker being intended to be utilized by functions for generating and predicting the critical symbols.

### CROSS-REFERENCE TO RELATED APPLICATIONS

The present Application is based on International Application No. PCT/EP2007/055201, filed on May 29, 2007, which in turn corresponds to French Application No. 0605002, filed on Jun. 6, 2006, and priority is hereby claimed under 35 USC §119 based on these applications. Each of these applications are hereby incorporated by reference in their entirety into the present application.

### 1. FIELD OF THE INVENTION

The field of the invention is that of the dependability of operation of viewing systems. The field of application is more particularly that of cockpit systems on board aircraft. This type of system is intended to display information critical for the piloting of the aircraft. In this respect, the erroneous display of certain parameters may lead to a catastrophic situation in terms of dependability of operation. The basic integrity of the viewing chain not being sufficient to guarantee these dependability requirements, it is necessary to implement monitoring mechanisms intended to detect such errors.

### 2. DESCRIPTION OF THE PRIOR ART

The problem of verifying and monitoring the quality of an image consists essentially in identifying characteristic elements of this image and in then analyzing whether these elements remain correctly disposed along the viewing chain. This problem has been solved in two different ways in the current solutions:
In the first case, the solution consists in verifying the result of the calculations applied to the characteristic points of the image by the graphical generation chain, but without propagating the marking information for these points up to the image memory;
In the second case, the solution consists in calculating the image by two dissimilar pathways and in then comparing the graphical result during simultaneous readout of the two image memories.

The technique implemented in the first case consists in identifying the characteristic points of the image during its specification by associating a marker with them. These characteristic points thus retain their marker the whole way along the image calculation chain, thereby allowing the graphical generation to be capable of providing an external verification module with the result of the calculations applied to these points. Once these calculation results are available, it is then possible to verify whether they comply with the expected results. This solution has several drawbacks:
It applies only to specific graphical generation solutions which are:
   Capable of accepting markers on the characteristic points provided as input to the calculation chain;
   Capable of propagating the marker along the calculation chain;
   Capable of extracting the results of the calculations applied to the characteristic points.
It does not cover the phase of writing the characteristic points to the image memory and the image memory readout phase, so that corruption of the points either in terms of position, or by erasure is not covered by this mechanism.
It requires complementary mechanisms which make it possible to verify the integrity of the phases of accessing the image memories such as writing, reading or the exchanging of data also called “swap”.

The technique implemented in the second case consists in verifying the content of an image through pixel by pixel comparison of the image arising from two dissimilar and independent pathways. Verification is then carried out by comparing colors. It requires the management of an adapted tolerance threshold which makes it possible not to require each of the graphical generation pathways to have a strictly identical result. This technique has several variants, such that one pathway generates the complete image and the other pathway generates only the elements of the image whose integrity has to be verified. This solution has several drawbacks. Specifically, it requires the implementation of two dissimilar graphical generation chains, with significant impacts in terms of performance and development cost. Moreover, it is necessary to demonstrate that the tolerance threshold implemented for calorimetric comparison of the images makes it possible to guarantee the integrity of the image in all cases. The determination of this “proper” threshold is tricky to obtain.

### SUMMARY OF THE INVENTION

The aim of the invention is to provide at the output of the graphical generation chain labels in the image which will make it possible to guarantee the integrity of display of the onboard viewing chain. These labels are in particular associated with the critical symbols of the image and make it possible to verify the integrity of these symbols. The invention consists in formulating the sequence of graphical operations which leads to the insertion of labels in the form of bits set to “1” at the location of the bits that are not used in the so-called RGB color components, the acronym standing for Red-Green-Blue.

More precisely, the subject of the invention is a method of coding the pixels of a color digital image comprising critical symbols represented by critical pixels, each colored pixel being coded on three digital components each comprising the same number of bits, characterized in that the components of the critical pixels comprises on the one hand color information and on the other hand a marker also called a “tag” coded on at least one bit, said marker being intended to be utilized by functions for generating and predicting the critical symbols.

Advantageously, the components are coded on eight bits, two of the components comprising color information coded on five bits and one of the components comprising color information coded on six bits.

Advantageously, the color information is coded on the low-order bits or LSBs (Least Significant Bits).

Advantageously, the method is carried out in a device for generating digital images comprising a calculation unit of GPU type comprising at least one image memory, a memory dedicated to the “masks” also called “stencils” comprising at least one memory plane and a graphics processor, and said method comprises at least four steps:
A first step of generating the non-critical symbols in the image memory;
A second step of generating the critical symbols in the image memory and of generating the markers associated with said critical symbols in a memory plane of the memory dedicated to the “masks”;
A third step of creating the image coded by the graphics processor while incorporating said markers into the components of the pixels of the critical symbols;
A fourth step of reading out the coded image.

The invention also relates to an electronic device for generating digital images comprising a calculation unit of GPU type (Graphic Processing Unit) characterized in that it comprises a coding method as claimed in one of the preceding claims.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious aspects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 represents the general schematic of an electronic device for generating digital images according to the invention;

FIG. 2 represents the main steps of the method according to the invention;

FIG. 3 represents the general schematic of an electronic device for securing digital images comprising an electronic device for generating digital images according to the invention.

### DETAILED DESCRIPTION OF THE INVENTION

The basic principle of the invention includes:
Implementing a mechanism for marking the pixels in the image which covers overall:
   The chain for calculating the characteristic points of the image,
   The writing of the points to the image memory,
   The exchanging also called “swap” and the reading of the image memories.
Utilizing solely generic graphical resources available on the standard image generation chains of OpenGL type. OpenGL, the acronym standing for Open Graphics library, is a multi-platform programming interface for the design of applications generating two- or three-dimensional images. This interface encompasses different functions which can be used to display complex three-dimensional scenes on the basis of simple primitives;
Positioning markers in the image for each pixel of any graphical primitive identified as belonging to a critical symbol.

So that this coding method can be applied, three conditions must be fulfilled:
The graphical generation chain provides the image in a digital video format in which the colors are represented by their three RGB (Red, Green and Blue) components;
It is possible to code the useful colors used by the elements constituting the image on a smaller number of bits than that available at the output of the graphical generation chain;
The graphical generation chain has a memory resource dedicated to managing the masks. By way of illustration, in the OpenGL standard, this resource is called the “stencils”. This memory resource is used for managing the markers.

These conditions are generally satisfied in all standard graphical environments, and in particular in the openGL environment. Specifically, the digital video outputs of the standard current graphical generation chains propose eight bits as standard per RGB component. The low-order bits are conventionally called LSBs, LSB being the acronym standing for Least Significant Bit and the high-order bits are conventionally called MSBs, MSB being the acronym standing for Most Significant Bit. Now, it is clear that the coding of the color pixels of a symbology does not require as significant a color range as that of a real image. Generally, a few tens of colors suffice to code the whole set of characters and symbols. It is possible, consequently, to code the useful colors using only a limited number of bits of each component. By way of example, a typical configuration may be:

5 bits on the LSBs of Red;

6 bits on the LSBs of Green and;

5 bits on the LSBs of Blue.

Thus, at least three bits remain available on at least two of the components. Moreover, the coding of the marker requires only a limited number of bits, generally one bit suffices. Thus, it is possible to code both the color information and the marking information on one and the same component.

The various steps of the method consist in formulating the sequence of graphical operations which leads to inserting for each pixel the marker stored in the masks memory at the location of the bits that are not used in the RGB color components, while taking account of the particular rules and constraints related to the use of graphics processors.

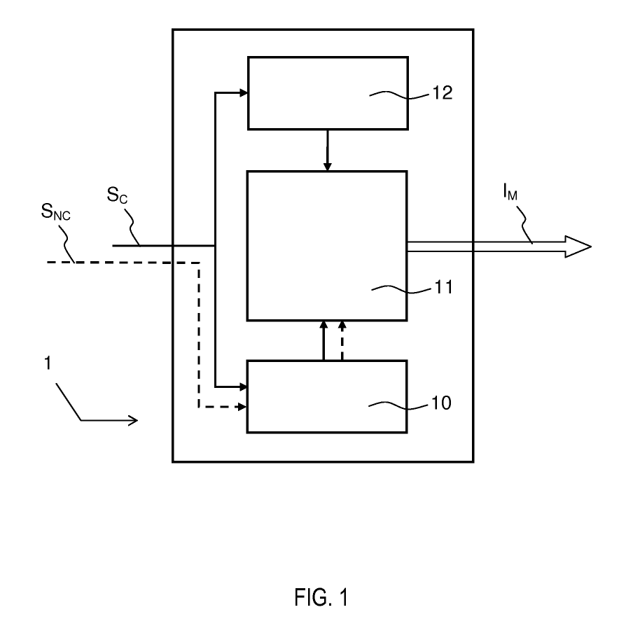

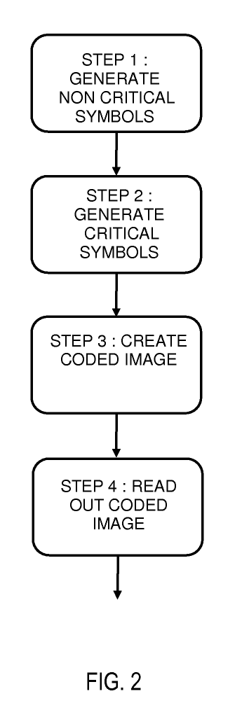

In a more detailed manner and by way of example, when it is implemented in a GPU, the method as a whole comprises four steps denoted 1, 2, 3 and 4 which are detailed below. These various steps are illustrated by FIGS. 1 and 2. In FIG. 1, the course of the non-critical symbols S_{NC} is represented by dotted arrows and the course of the critical symbols S_{C} is represented by continuous arrows:
Step 1: any non-critical symbol S_{NC} is generated conventionally in the image memory 10 of the GPU 1 in the RGB format, each pixel being coded on five bits on the LSBs of Red, six bits on the LSBs of Green and five bits on the LSBs of Blue;
Step 2: any critical symbol S_{C} is generated simultaneously in the image memory 10 in the RGB format and in a memory plane 12 dedicated to the masks which is one bit deep. In this step, any pixel written to image memory, and whatever its color, is assigned a corresponding pixel set to “1” in the mask plane. When the image is fully generated, the RGB color image is available in the image memory and the pixelwise markers are available in the mask plane. Each pixel is coded on five bits on the LSBs of Red, six bits on the LSBs of Green and five bits on the LSBs of Blue;
Step 3: This step consists in inserting by means of the calculation unit 11 of the GPU 1 a marker into the image memory for each pixel for which there is a corresponding one set to “1” in the mask plane. The technique used consists in plotting a surface or a set of surfaces:
   Which cover the zone of the image into which the markers have to be inserted. By way of example, depending on the significance of the symbology generated, a single surface can overlap the whole of the image or one or more surfaces can overlap a sub-set of the image;
   Which are assigned a color whose active bits correspond to the markers which are inserted into the image memory. These active bits must be positioned on the bits of the image memory that are not used;
   Which will be subjected to a color mixing law such that, if a pixel of the mask plane is set to 1, then the color of the surface(s) plotted will be added to the color already present in the image memory.
Step 4: This step corresponds to the reading out of the image memory by the graphical generation chain which then provides pixelwise on the digital video output the combination of the RGB color information and of the marking information for the pixels. This image comprising markers is denoted I_{M}.

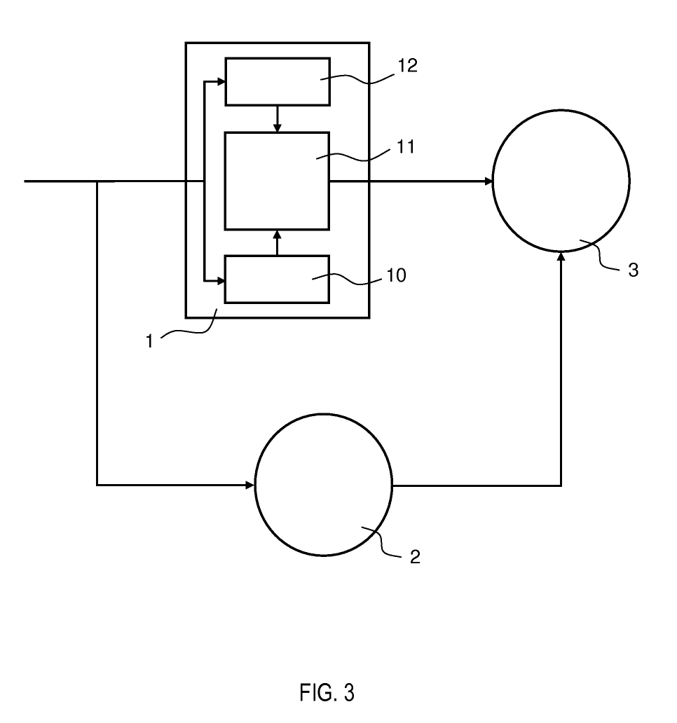

A portion of secure graphical generation chain implementing the method according to the invention is described in FIG. 3. It essentially comprises:

A graphical calculation unit of GPU type 1;

A prediction calculation unit 2;

An extraction and comparison unit 3.

The operating principle is as follows: the prediction calculation unit calculates the position of the critical symbols in the image. These calculations are compared by means of the extraction and comparison unit with the positions of the critical symbols tagged by their markers. It is thus known whether the graphical generation chain is operating correctly.

The advantages afforded by the implementation of such a mechanism for marking pixels at the output of a graphical generation chain with respect to the previous procedures are essentially:
The method applies to all types of graphical primitives which may be vectors or surfaces;
The method takes into account the functions for managing superposition or priority of the symbols, functions which, in the OpenGL language, are called “clipping”, “stencil” or “scissor” functions. Consequently, a primitive that is not plotted will not generate any markers;

Moreover, the method is independent:
Of the mixture of colors necessary for the functions termed “anti aliasing”, or “blending”;
Of the plotting procedures of the “vectors”, “textured quads” type, etc;
Of the order of plotting of the symbols,
Of the use of the “Z-Buffer” which defines the priority rules between symbols;
Of the type of OpenGL compatible GPU used.

The method is also efficacious:
It allows simultaneous writing to the image memory and the mask plane with no impact on the required performance;
It is possible to optimize the surface area of the additive mixing zone by limiting it to the zones containing the critical symbols.

The solution afforded is extendible to a number N of mask planes. In the case of non-superimposed critical symbols, it is thus possible to manage 2N markers or tags. In the case of superimposed critical symbols, it is then possible to manage N different tags.

The solution afforded is compatible with automatic code generation while including code portions in the following manner:
Code portion to be inserted at the start of the plot of a symbol so as to trigger storage in the mask plane,
Code portion to be inserted at the end of the plot of a symbol so as to disable storage in the mask plane,
Code portion to be inserted at the end of the image plot so as to trigger additive mixing.

This novel mechanism makes it possible to guarantee the integrity of the novel viewing technologies based as much on proprietary solutions as on off-the-shelf solutions termed COTS, the acronym standing for Component Off The Shelf.

It will be readily seen by one of ordinary skill in the art that the present invention fulfils all of the objects set forth above. After reading the foregoing specification, one of ordinary skill in the art will be able to affect various changes, substitutions of equivalents and various aspects of the invention as broadly disclosed herein. It is therefore intended that the protection granted hereon be limited only by definition contained in the appended claims and equivalents thereof.

1. A method of coding the pixels of a color digital image generated by a cockpit system on board an aircraft, said image comprising critical symbols represented by critical pixels, a critical symbol being a symbol displaying information critical for the piloting of the aircraft, each colored pixel being coded on three digital components each comprising the same number of bits, wherein the components of the critical pixels comprise color information and a marker also called a “tag” coded on at least one bit, said marker being intended to be utilized by functions for generating and predicting the critical symbols.

2. The coding method as claimed in claim 1, wherein the components are coded on eight bits, two of the components comprising color information coded on five bits and one of the components comprising color information coded on six bits.

3. The coding method as claimed in claim 1, wherein the color information is coded on the low-order bits or LSBs (Least Significant Bits).

4. The coding method as claimed in claim 1 carried out in a device for generating digital images comprising a calculation unit of GPU type comprising at least one image memory, a memory dedicated to the masks comprising at least one memory plane and a graphics processor, the said method comprising at least four steps:
a first step of generating the non-critical symbols in the image memory;
a second step of generating the critical symbols in the image memory and of generating the markers associated with said critical symbols in a memory plane of the memory dedicated to the masks;
a third step of creating the image coded by the graphics processor while incorporating said markers into the components of the pixels of the critical symbols; and
a fourth step of reading out the coded image.

5. An electronic device for generating digital images comprising a calculation unit of GPU (Graphic Processing Unit) type comprising a coding method as claimed in claim 1.

6. An electronic device for generating digital images comprising a calculation unit of GPU (Graphic Processing Unit) type comprising a coding method as claimed in claim 4.

7. The coding method as claimed in claim 2, wherein the color information is coded on the low-order bits or LSBs (Least Significant Bits).

8. The coding method as claimed in claim 2 carried out in a device for generating digital images comprising a calculation unit of GPU type comprising at least one image memory, a memory dedicated to the masks comprising at least one memory plane and a graphics processor, the said method comprising at least four steps:
a first step of generating the non-critical symbols in the image memory;
a second step of generating the critical symbols in the image memory and of generating the markers associated with said critical symbols in a memory plane of the memory dedicated to the masks;
a third step of creating the image coded by the graphics processor while incorporating said markers into the components of the pixels of the critical symbols; and
a fourth step of reading out the coded image.

9. The coding method as claimed in claim 3 carried out in a device for generating digital images comprising a calculation unit of GPU type comprising at least one image memory, a memory dedicated to the masks comprising at least one memory plane and a graphics processor, the said method comprising at least four steps:
a first step of generating the non-critical symbols in the image memory;
a second step of generating the critical symbols in the image memory and of generating the markers associated with said critical symbols in a memory plane of the memory dedicated to the masks;
a third step of creating the image coded by the graphics processor while incorporating said markers into the components of the pixels of the critical symbols; and
a fourth step of reading out the coded image.
